(19) United States
(12) Patent Application Publication
(10) Pub. No.: US 2026/0107147 A1
(43) Pub. Date: Apr. 16, 2026

(54) METHOD FOR DETECTING ANOMALIES ON WI-FI STATIONS

(71) Applicant: SOFTATHOME, COLOMBES (FR)

(72) Inventor: Quentin FERABOLI, Nanterre (FR)

(21) Appl. No.: 19/113,709

(22) PCT Filed: Oct. 31, 2023
(86) PCT No.: PCT/EP2023/080392

§ 371 Date: Mar. 20, 2025

(30) Foreign Application Priority Data
Nov. 10, 2022 (FR) FR2211748

(51) Int. Cl. H04W 12/122; H04L 9/06; H04W 12/69; H04W 84/12

(52) U.S. Cl. CPC H04W 12/122; H04L 9/0643; H04W 12/69; H04L 2209/80; H04W 84/12

(57) ABSTRACT

A method for detecting an anomaly with regard to the association of a Wi-Fi station with an access point of a communication network, including each time the Wi-Fi station sends a Wi-Fi standard management frame, referred to as “Probe Request”, including a MAC address and a content item, carrying out the following steps:—identifying the content item,—applying a unique identification algorithm to the content item so as to generate a unique identification code for the content item,—storing the unique code within the access point, -checking whether the Wi-Fi station is associated with the access point,—if it is not associated, checking whether the unique code is known in the access point and whether the Wi-Fi station linked to this unique code has already been associated with the access point;—if it is, generating an alert signal is disclosed.

### TECHNICAL FIELD

The present invention relates to a method for detecting an anomaly in the association of a Wi-Fi station with an access point of a communication network.

One such network is a home network equipped with a gateway as an access point for connecting local equipment to the Internet.

### PRIOR ART

Generally speaking, Wi-Fi is the most widely used medium for transmitting data in the home. It is used from a large and growing number of different devices (smartphone, tablet, PC, television set-top box, IOT equipment, etc.) and a wide range of uses: e-mail, telephony, live video, OTT video, IOT monitoring, etc.

Wi-Fi technologies are becoming increasingly complex, with additional tools to optimize certain characteristics of the transmissions while taking into account certain constraints: 802.11e, 802.1 lu, 802.11ax, OFDMA, etc.

Similarly, as Wi-Fi technologies are evolving very quickly, some Wi-Fi equipment already on the market is occasionally incompatible with these evolutions. It is important for a telecom operator deploying a new Wi-Fi technology in a home to not introduce any new problems into its customers'Wi-Fi equipment.

Some stations may find it difficult to use a gateway's Wi-Fi network. These difficulties manifest themselves as an inability to establish a Wi-Fi connection, for a variety of reasons: incompatibility of the Wi-Fi station with a particular Wi-Fi standard, incompatibility with a security mode currently in use by the home gateway, or an old Wi-Fi driver present on the customer's equipment.

It's difficult to detect that a Wi-Fi station is no longer able to connect to the network, as it may be using a random MAC address. The home gateway is therefore unable to distinguish whether it is a Wi-Fi station already known to its network.

The purpose of the present invention is to detect anomalies in the Wi-Fi connection between Wi-Fi stations and a gateway within a home network.

Another aim of the invention is to optimize the management of Wi-Fi stations within a communication network access point.

### DISCLOSURE OF THE INVENTION

At least one of the above objectives is achieved with a method for detecting an anomaly in the association of a Wi-Fi station with an access point of a communication network. According to the invention, each time the Wi-Fi station sends a management frame from the Wi-Fi standard, known as a “Probe Request”, comprising a MAC address and a content item, the following steps are carried out:
identifying the content item,
applying a unique identification algorithm to the content item so as to generate a unique identification code for the content item,
storing the unique code within the access point,
checking whether the Wi-Fi station is associated with the access point,
if it is not associated, checking whether the unique code is known in the access point and whether the Wi-Fi station linked to this unique code has already been associated with the access point;
if the unique code is known in the access point and if the Wi-Fi station linked to this unique code has already been associated with the access point, generating an alert signal.

The invention uses a management frame from the Wi-Fi standard, the “Probe Request”. This is used by Wi-Fi stations to identify nearby networks. This is a relevant indicator, because during an association attempt, this “Probe Request”is always sent by the Wi-Fi station.

If this Wi-Fi standard management frame is present, but the Wi-Fi station linked to this Wi-Fi standard management frame is not associated with the network access point, then it is assumed that there is an interoperability problem between the access point and this Wi-Fi station. The present invention therefore makes it possible to detect the presence of this “Probe Request” by associating it with a Wi-Fi station known to the access point.

Unique identification could be achieved using the Wi-Fi station's physical address, that is, its MAC address. However, as this address, which is supposed to be unique, is sometimes changeable, the present invention provides for the creation of a unique invariable code.

By retaining only the contents of the “Probe Request”, the random component is removed, and the access point is able to link the “Probe Request”to a known device on the network.

Thus, at the next association attempt, the Wi-Fi station will therefore send a “Probe Request”, the unique code calculated from this “Probe Request” is known to the access point and the Wi-Fi station linked to this unique code is not connected, then the access point considers that this Wi-Fi station is unable to associate and sends an alert. If the station manages to connect, the alert is removed.

Checking whether the Wi-Fi station linked to the unique code has already been associated with the access point consists of checking whether the Wi-Fi station has subsequently been associated and then disassociated from the access point, that is, whether there has already been a successful association before.

The check to see if the Wi-Fi station is associated with the access point is carried out immediately, each time a “Probe Request” is received by the access point.

With the method according to the invention, if an operator decides to modify a Wi-Fi parameter on an access point, the operator is informed of any incompatibilities with a customer's Wi-Fi equipment, even if the customer uses a random MAC address.

According to an advantageous feature of the invention, the unique identification algorithm can be a hash function.

More precisely, this function can be an MD5 cryptographic hash function. This function calculates a unique identifier from a digital content item. This makes it possible to distinguish between Wi-Fi stations.

According to an advantageous embodiment of the invention, the communication network may comprise several access points including a gateway and at least one repeater, with the unique code storage and verification steps being carried out within the gateway.

In this case, the step of checking whether the Wi-Fi station linked to the unique code has already been associated concerns all the access points. We check that the Wi-Fi station has not already been associated with one of the access points.

According to the invention, a gateway processing unit can be configured to carry out the steps of the method according to the invention. The intelligence is in the gateway.

In other words, in a network including repeaters and a home gateway, each time a “Probe Request” is received on one of the network devices, a unique code is calculated and then saved in the home gateway for future comparison.

According to one embodiment of the invention, the content item may comprise a number of antennas of the Wi-Fi station or a maximum frequency band of the Wi-Fi station. These elements relate to the equipment's Wi-Fi capabilities. Of course, the content of the Wi-Fi standard management frame may comprise elements other than those listed.

According to a preferred embodiment of the invention, for IEEE 802.11 communication, the content is the “IEEE 802.11 Wireless management” part. In particular, variable information such as the destination or source address is not retained.

In one embodiment of the invention, the communications network can be a home network, with the access point comprising an Internet connection router.

Such a router can be, for example, a gateway, a “homegateway”, or any other device capable of connecting user equipment to the Internet.

According to another aspect of the invention, a communication network is proposed for detecting an anomaly in the association of a Wi-Fi station with an access point; this access point being configured to implement a method according to the invention.

The present invention also relates to a computer program product comprising instructions which, when the program is executed by a processing unit in an access point, cause the latter to implement the method according to the invention.

### DESCRIPTION OF THE FIGURES AND EMBODIMENTS.

Other benefits and features shall become evident upon examining the detailed description of entirely non-limiting embodiments and implementations, and from the following enclosed drawings:

FIG. 1 is a schematic view of a house equipped with an access point in the form of an Internet gateway and user Wi-Fi stations;

FIG. 2 is a flowchart showing the steps of a method according to the invention;

FIG. 3 is a schematic view showing the fields in a “Probe Request” Wi-Fi standard management frame according to the invention;

FIG. 4 is a simplified schematic view of frames sent by a Wi-Fi station to an access point; and

FIG. 5 is a simplified schematic view of frames sent by a Wi-Fi station to an access point according to the invention.

The embodiments which will be disclosed hereinafter are in no way limiting; in particular, it is possible to implement variants of the invention that comprise only a selection of the features disclosed hereinafter in isolation from the other features disclosed, if this selection of features is sufficient to confer a technical benefit or to differentiate the invention with respect to the prior art. This selection comprises at least one preferably functional feature which lacks structural details, or only has a portion of the structural details if that portion only is sufficient to confer a technical benefit or to differentiate the invention with respect to the prior state of the art.

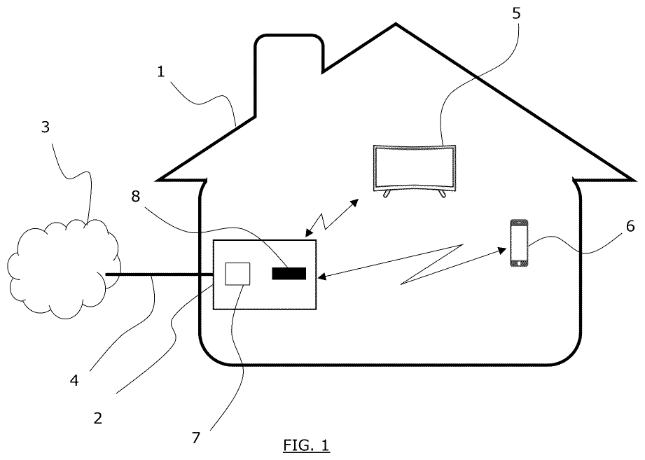

FIG. 1 is a schematic view showing a home 1 equipped with an access point 2, which is a gateway providing access to the Internet 3 via a wired link 4 based on coaxial cable or fiber optics.

The access point 2 comprises a processing unit 7, such as a microcontroller for example, to implement the method according to the invention and a Wi-Fi module 8 for wireless communication with equipment.

Equipment in the home can connect wired or wirelessly to the access point 2 to access the Internet 3.

In the example shown in FIG. 1, a television set 5 and a Wi-Fi station such as a smartphone-type cell phone 6 are both wirelessly connected to the gateway 2 via Wi-Fi. In particular, when the television set 5 is on, a digital television service is activated between the television set 5 and the access point 2.

The cell phone 6 is able to connect to the gateway 2 to access the Internet by implementing different types of services: web, downloading, telephony, etc.

The combination of access point 2, television set 5 and cell phone 6 forms a home network.

The access point 2 comprises conventional hardware and software means for acting as an access point and repeater between equipment and the Internet, and further comprises one and/or both of a computer program product for implementing the method according to the invention.

When the cell phone 6 is activated, it tries to identify nearby Wi-Fi access points. When an access point is identified, an association attempt is made.

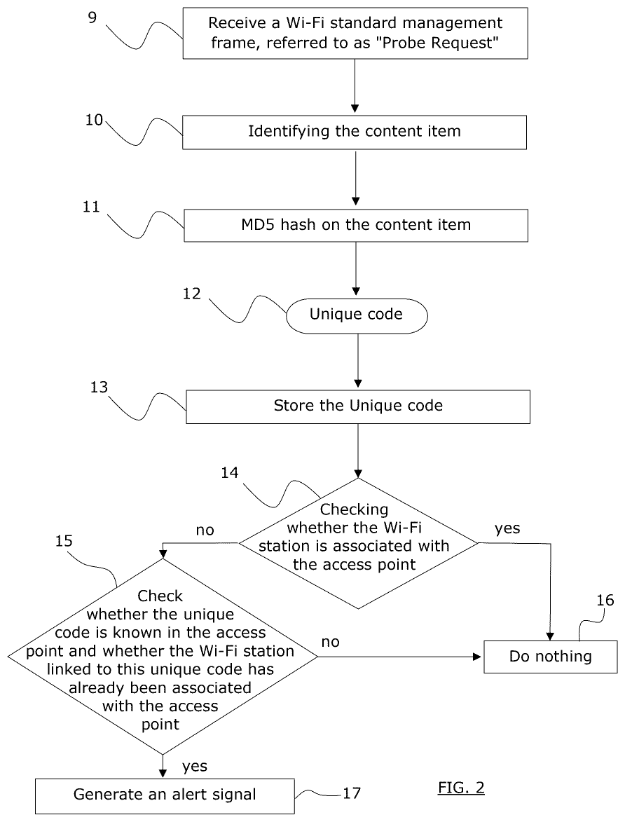

FIG. 2 is a flowchart showing the steps of implementing the method according to the invention.

In step 9, the Wi-Fi station transmits a Wi-Fi standard management frame, referred to as “Probe Request”. This frame is received by the access point 2, which is a domestic gateway to the Internet. The frame comprises a MAC address and a content item.

FIG. 3 shows a screenshot of the frame. A distinction is made between a first part, which is the frame header, and a second part, which is the content item according to the invention. The first part comprises fields between “type/Sub-type:” and “[FCS Status: Unverified]”. The content item according to the invention comprises all the characteristics entered in the fields ranging from “Tagged parameters”to “Tag: Vendor Specific: Broadcom”.

In step 10 in FIG. 2, the access point identifies the content according to the invention.

A digital file is then created. Then, in step 11, an MD5 hash is applied to this digital file to obtain a unique code 12.

In step 13, the unique code is saved in the gateway.

In step 14, the method checks whether the Wi-Fi station, that is, the phone 6, is associated with the access point 2.

If it is, “yes”, nothing happens in step 16.

If not, “no”, in step 15 the method then checks whether the unique code is known in the access point and whether the Wi-Fi station linked to this unique code has already been associated with the access point. This is done to try to find out whether the phone 6 has already been associated with the access point 2 at least once in the past.

If not, “no”, nothing happens in step 16.

If so, “yes”, an alert signal is generated, via the Internet for example, to an operator's remote server. This alert signal can advantageously remain local to the gateway but can also be propagated in the home network or in the cloud through a secure tunnel (MQTT) in both cases.

When the alert signal is local, it may be a software signal sent to a gateway application for corrective action, and/or a message sent over the local area network to other network equipment, such as a Wi-Fi repeater.

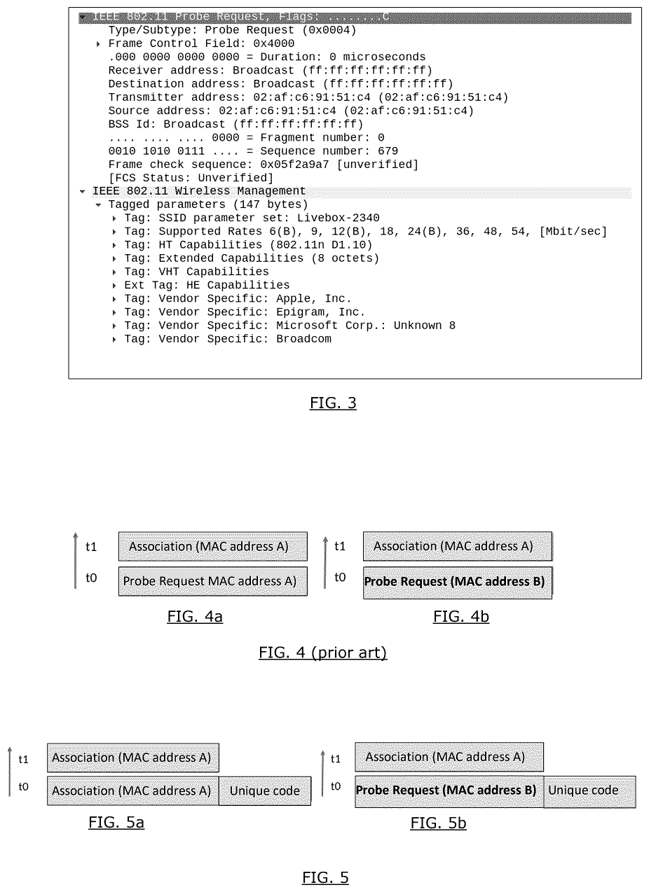

FIG. 4 shows an embodiment of the prior art. FIG. 4a shows a first association of the Wi-Fi station with the access point. FIG. 4b shows a second association of the Wi-Fi station with the access point at a later time.

FIG. 4a shows a first phase in which a Wi-Fi station transmits a “Probe Request” frame at time to. This frame obviously comprises the Wi-Fi station's MAC address. In a second step, during an association attempt at time t1, the Wi-Fi station also transmits the same MAC address. In such a situation, where the Wi-Fi station uses the same MAC address between the “Probe Request” and its association, it is easy for the access point to detect the presence of this equipment.

FIG. 4b shows a second phase in which a Wi-Fi station transmits a “Probe Request” frame at time to. This frame obviously comprises the Wi-Fi station's MAC address. Secondly, during an association attempt, at time t1, the Wi-Fi station transmits a MAC address different from the one sent in the “Probe Request”. In such a situation, the fact that the Wi-Fi station uses a different MAC address between the “Probe Request” and its association prevents the link between the “Probe Request”and the association from being made.

In particular, the MAC address is different depending on the manufacturer's implementation, to mask its presence and prevent the station from being identified.

It is therefore necessary to remove the random component from the “Probe Request”due to the fact that the MAC address is sometimes different.

The MAC address may be random, but not necessarily the data contained in the Probe Request. By separating the two sets and creating an MD5 hash of the content item, for example, a unique code is obtained for the Wi-Fi station, as shown in FIG. 5.

FIG. 5 shows an embodiment according to the invention. FIG. 5a shows a first association of the Wi-Fi station with the access point. FIG. 5b shows a second association of the Wi-Fi station with the access point at a later time.

FIG. 5a shows the same steps as FIG. 4a, with the addition here of the calculation of the unique code at time to when the “Probe Request” frame is received. During the association attempt, at time t1, the Wi-Fi station also transmits the same MAC address. In such a situation, where the Wi-Fi station uses the same MAC address between the “Probe Request” and its association, it is easy for the access point to detect the presence of this equipment.

FIG. 5b shows the same steps as FIG. 4b, with the addition here of the calculation of the unique code at time to when the “Probe Request” frame is transmitted. Likewise, let us consider the case where, during the association attempt, at time t1, the Wi-Fi station transmits a MAC address different from the one sent in the “Probe Request”. With the present invention, if the association does not take place, the unique code is used to identify the Wi-Fi station and establish that this Wi-Fi station had already associated in the past during the phase described in FIG. 5a.

Thus, with the method described in the invention, any anomaly in the connection of a Wi-Fi station to an access point is detected.

Of course, the invention is not limited to the examples disclosed above. Many modifications can be made to these examples without departing from the scope of the present invention as disclosed.

1. A method for detecting an anomaly in the association of a Wi-Fi station with an access point of a communication network, comprising:
each time the Wi-Fi station sends a management frame from the Wi-Fi standard, known as a “Probe Request”, comprising a MAC address and a content item, the following steps are carried out:
identifying the content item;
applying a unique identification algorithm to the content item so as to generate a unique identification code for the content item;
storing the unique code within the access point;
checking whether the Wi-Fi station is associated with the access point;
if it is not associated, checking whether the unique code is known in the access point and whether the Wi-Fi station linked to this unique code has already been associated with the access point; and
if the unique code is known in the access point and if the Wi-Fi station linked to this unique code has already been associated with the access point, generating an alert signal.

2. The method according to claim 1, characterized in that the unique identification algorithm is a hash function.

3. The method according to claim 1, characterized in that the unique identification algorithm is an MD5 cryptographic hash function.

4. The method according to claim 1, characterized in that the communication network comprises several access points including a gateway and at least one repeater, with the unique code storage and verification steps being carried out within the gateway.

5. The method according to claim 1, characterized in that the content item comprises a number of antennas of the Wi-Fi station.

6. The method according to claim 1, characterized in that the content item comprises a maximum frequency band of the Wi-Fi station.

7. The method according to claim 1, characterized in that for communication according to the IEEE 802.11 standard, the content item is the “IEEE 802.11 Wireless management” section.

8. The method according to claim 1, characterized in that the communication network is a home network, the access point comprising an Internet connection router.

9. A communication network for detecting an anomaly in the association of a Wi-Fi station with an access point, characterized in that the access point is configured to implement a method according to claim 1.

10. A computer program product comprising instructions which, when the program is executed by a processing unit in an access point, cause the latter to implement the steps of the method according to claim 1.
